(19) United States
(12) Patent Application Publication
(10) Pub. No.: US 2005/0243491 A1
(43) Pub. Date: Nov. 3, 2005

(54) Multi-function power monitor and circuit protector

(76) Inventor: James Tanis, New York, NY (US)

Correspondence Address: OSTRAGER CHONG FLAHERTY & BROITMAN PC, 250 PARK AVENUE, SUITE 825, NEW YORK, NY, 10177, US

(21) Appl. No.: 11/117,618

(22) Filed: Apr. 28, 2005

Related U.S. Application Data
(60) Provisional application No. 60/565,891, filed on Apr. 28, 2004.

(51) Int. Cl. H02H 5/04

(52) U.S. Cl. 361/104

(57) ABSTRACT

A compact and multi-functional power monitoring and circuit protection system is provided that is easily installed, used and modified, and internally derives all control and output power from the input voltages being monitored for abnormal power conditions. The functionality of all desired power monitoring and sensing devices is integrated into one unit controlled by a microprocessor. This substantially reduces the number of parts and control wiring required to achieve adequate power monitoring and circuit protection, and reduces the assembly and installation time. The integrated system uses only one set of voltage input wires, one set of current input wires, one set of blown fuse input wires and one output pair of wires to the power disconnect switch's shunt trip. Circuitry is provided to select one of the three power phases being monitored such that one of the three phases is always available to power the system. Control voltages for controlling the shunt trip and external circuits using output relays (to illuminate pilot lights, bell alarms, etc.) are also provided onboard the unit. A blown fuse detection circuit uses solid-state devices in lieu of replaceable trigger fuses. The unit can be instantly reset itself after a blown fuse condition in a power disconnect switch has been rectified.

### CROSS REFERENCE TO RELATED APPLICATIONS

This application claims the benefit of U.S. Provisional Patent Application No. 60/565,891 filed Apr. 28, 2004, the disclosure of which is incorporated herein by reference.

### FIELD OF THE INVENTION

This invention relates generally to a power monitoring and circuit protection system, and more particularly, to an integral system having multiple means for monitoring electrical power distribution systems and devices and protecting them against abnormal power conditions.

### BACKGROUND OF THE INVENTION

Electrical power distribution systems are used to bring electric service from a power utility into facilities such as residential, office and industrial buildings. Typically, the electric service provided by a power utility is in a three phase configuration. Each facility's distribution system includes a number of fused power disconnect switches, which switch power on and off, as well as protect against short circuits and overloads, including a main power disconnect switch and several branch power disconnect switches.

With the rapid advancement of technology, electrical and electronic products used in such facilities have become quite sensitive to abnormal power conditions, which may cause interruption in use or failure of the products. Abnormal power conditions may arise, for example, from power utility failure in the form of under-voltages, over-voltages, voltage unbalances, phase reversals, phase angle errors or phase losses. Other abnormal power conditions may occur within a facility itself, such as blown fuses, over-currents, current unbalances or abnormal equipment operating temperature. It has therefore become necessary to protect power sensitive products from such abnormal power conditions.

Many devices for sensing and protecting against abnormal power conditions are known. However, prior devices have various shortcomings in installation, operation and maintenance. Prior devices are typically available in individual packages or stand-alone units (e.g., one package to detect under-voltages, one package to detect blown fuses, one to generate a control power source, etc.), each comprising a sensing circuit or relay. To achieve the desired level of protection from a variety of abnormal power conditions, a series of prior individual packages must be manually wired together and to an external power supply to create a complete power monitoring and protection system for each power disconnect switch.

For example, a wiring diagram for a typical prior art system for power monitoring and circuit protection is shown in FIG. 1 (within the dashed border line), as wired to a facility's power disconnect switch 10, which feeds power to a load. The power disconnect switch employs a separate fuse 12 for each of the three phases (labeled ØA, ØB, ØC) for basic over-current and short circuit protection. The switch 10 also employs a shunt trip solenoid 14, which, when activated, opens the power disconnect switch 10 to disconnect power delivered to the load. A shunt-trip opens a power disconnect or circuit breaker with a low power electrical signal, rather than opening it manually.

Under normal operating conditions, each of the main fuses 12 pass load current from the power source and permit that current to be fed to the load. Prior art blown fuse protection occurs when one of the main fuses 12 is blown and a smaller trigger fuse 16 (shown in FIG. 7A) attempts to carry the load current. The trigger fuse 16 is designed to burn under minimal current. Upon burning, the trigger fuse 16 extends an actuating arm 18 to actuate a micro-switch 20. Using an external power source 34, the micro-switch is wired to actuate the shunt trip solenoid 14. This will open the power disconnect switch 10 and shut off all power to the load. To restore power, all of the blown fuses (main fuses and trigger fuses) must be manually replaced, imposing added costs and difficulties in maintaining the system.

The prior art system shown in FIG. 1, as an example, includes individual packages or relays for sensing phase failure 22, under-voltage 24, phase rotation 26, over-current 28 and blown fuses 30 in the power service lines. Each of the three phases is tapped for voltage 42 and provided as a separate input to each of the individual relays, such that each sensing relay has at least three inputs. The over-current sensing relay 28 uses three-phase current inputs that are stepped down from the service operating current by current transformer 44 in the facility's power disconnect 10. A typical current transformer has a 5 A secondary. For example, if the power disconnect switch is rated at 4000 amps, the current transformer used to step-down the current will have a 4000:5 amp ratio. A fourth current input is the ground reference point for the current transformers.

Each of the individual sensing relays are typically provided with one, dry-type, Form ‘C’, output contact 32, which is energized under normal conditions and drops out under a fault (dead-man's switch). However, these dry output contacts have no internal power source and require an external power source to make them functionally operative. Using an external power source, the dry contacts 32 may be used to illuminate pilot lights, sound an alarm, operate the shunt-trip feature of power disconnects, or drive additional relays if additional contacts are needed. In this prior art example, each of the output contacts 32 are wired directly to the shunt trip 14, such that if any of the relays sense an abnormal power condition, the shunt trip is activated and the power disconnect switch 10 is opened to shut power off.

In FIG. 1, the control power that enables each dry-type output contact 32 to activate the shunt trip must be derived by external means, e.g., transformer 34. The control power is applied by additional wiring 36 to the dry contacts 32 of each of the individual sensing relays 22, 24, 26, 28, 30 to achieve functional output to operate the shunt trip 14. If the system requires more output contacts, for example, to sound an alarm or illuminate a pilot light, additional stand-alone relays, such as auxiliary contacts 38, must be connected in parallel with the relay contacts 32. Each of these auxiliary contacts can only be associated with one of the sensing relays. If the auxiliary contacts 38 require power to perform a function (e.g., illuminate pilot lights, ring buzzers, etc.) an additional external power source, such as the control power transformer 34, must be provided.

Although prior systems are functionally effective, these systems require many different parts and extensive control wiring, which in turn require substantial assembly and installation time and expense. A protection system including several individual packages, like the system shown in FIG. 1, for example, requires hundreds of control wire terminations. Due to the complex wiring, the risk of mis-wiring any of the connections is great and troubleshooting the system is difficult. Existing systems also require a substantial amount of space due to the size of each individual package and the resulting required wiring. Further, existing systems are limited in function by the way they are installed. If contacts or relays are to be used for a different purpose, the system must be manually re-wired for each different application, which imposes added costs and reduces efficiency.

### SUMMARY OF THE INVENTION

In accordance with the present invention, a compact and multi-functional power monitoring and circuit protection system is provided that is easily installed, used and modified, and internally derives all control and output power from the input voltages being monitored, thereby overcoming the above-mentioned shortcomings of known power monitoring and circuit protection systems.

In a preferred embodiment of the invention, the functionality of all of the desired power monitoring and sensing devices is integrated into one compact and integral unit controlled by a microprocessor. This substantially reduces the number of parts and control wiring required to achieve adequate power monitoring and circuit protection, and reduces the assembly and installation time. For example, the extensive control wiring shown in the prior art system of FIG. 1 is virtually eliminated. Instead, the integrated system requires only one set of voltage input wires, one set of current input wires, one set of blown fuse input wires and one output pair of wires to the power disconnect switch's shunt trip. By eliminating the need for manual assembly of stand-alone devices, the possibility of any mis-wiring is also eliminated. Having all the required components in a single integral unit also eliminates certain liabilities and the time spent troubleshooting. Further, in many situations, space is at a premium. The apparatus of the present invention significantly reduces the space needed to protect electrical products from any abnormal power conditions.

As a further aspect of the present invention, the control power required for powering all circuits in, and controlled by, the power protection system is derived from the voltage being monitored. For example, the voltage being monitored supplies power to the input circuits, the microprocessor, the output circuits and all relays for use in illuminating a pilot light or sounding a buzzer. Circuitry is provided to select one of the three power phases being monitored such that one of the three phases is always available to power the monitoring system. Control voltages for the shunt trip and external circuits using the output relays (to illuminate pilot lights, bell alarms, etc.) are also provided onboard the unit.

As a further aspect of the invention, the device can be used for any number of operating voltages, up to 600V AC. A programmable gain amplifier, embedded in the microprocessor, enhances the digital resolution of lower voltage levels.

As a further aspect of the invention, the blown fuse detection circuit is non-destructive (no parts to replace). This is achieved using solid-state devices in lieu of replaceable trigger fuses. The unit can instantly reset itself after a blown fuse condition in the facility's power disconnect switch has been rectified.

As a further aspect of the invention, the integral unit has the ability to assign more than one output relay to a specific sensing circuit or more than one sensing circuit to a specific output relay, eliminating the restriction of having just one Form ‘C’ contact per sensing circuit. For the purpose of functional output (shunt trip, pilot lights, audible alarms, etc.), the circuits of the present invention also provide an onboard voltage source, eliminating the need for external control voltage sources.

Other objects, features and advantages of the present invention will be apparent when the detailed description of the preferred embodiments of the invention is considered in conjunction with the drawings, which should be construed in an illustrative and not limiting sense as follows:

### BRIEF DESCRIPTION OF THE DRAWINGS

FIG. 1 is a wiring schematic of a typical prior art power protection system wired to a typical power disconnect switch.

FIG. 2 is a wiring schematic of a power protection system in accordance with the invention wired to a typical power disconnect switch.

FIG. 3 is a circuit diagram of a phase selection circuit for selecting a phase of the power being monitored to use for energizing the power protection system of the invention.

FIG. 4 is a circuit diagram of a shunt trip circuit for the power protection system of the invention.

FIG. 5 is a representation of an LCD Setup Menu for use with the power protection system of the invention.

FIG. 6 is a block diagram showing the current and voltage flow of the power protection system of the invention.

FIG. 7A is a wiring diagram showing a prior art blown fuse detector for use in a typical prior art power protection system.

FIG. 7B is a wiring diagram showing a blown fuse detector for use in the power protection system of the invention.

FIG. 7C is a schematic of the blown fuse detection circuit for use in the power protection system of the invention.

FIG. 8 is a schematic of the pin out arrangement of a microprocessor for use in the power protection system of the invention.

FIG. 9 is a schematic of a voltage input circuit prior to entering the microprocessor.

FIG. 10 is a schematic of a current input circuit prior to entering the microprocessor.

FIG. 11 is a schematic of the pin out arrangement of an output relay driver for use in the power protection system of the invention.

### DETAILED DESCRIPTION OF PREFERRED EMBODIMENTS

A preferred embodiment of the invention is herein described in detail, and is sometimes referred to as a “power protection system”. It is to be understood that while a particular system configuration, circuit layouts, and modes of operation are described, other modifications and variations may be made thereto in accordance with the general principles of the invention disclosed herein.

The power protection system is an integrated electronic system used to monitor the power utilized in a facility for abnormal power conditions and causing a power disconnect switch to open when certain abnormal power conditions are detected. The system may be used to control any of the power disconnect switches in a facility, including the main power disconnect switch and any of the branch disconnect switches. The system includes the functionality of the existing stand-alone power sensing packages described above, as well as other types of power regulation, power monitoring and fault detection circuits, the required wiring (circuitry) and control power to make them function as a whole. All of the power monitoring and circuit protection devices are combined onto a single printed circuit board and controlled by a microprocessor. The circuit board and all necessary input/output ports are placed in a single enclosure having an LCD screen or other type of user interface for a user to select the desired power monitoring features. Thus, the power protection system is readily portable, and easily installed, maintained and modified. If a facility has more than one power service line that requires monitoring, a second power protection system may be installed and both systems can be synchronized together.

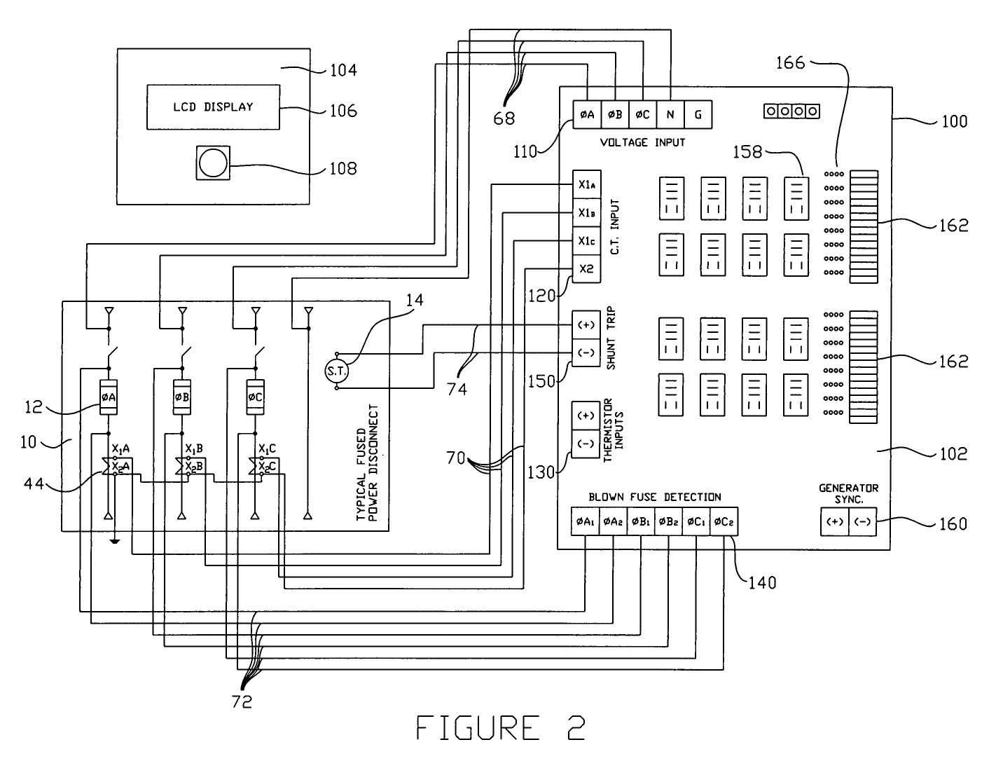

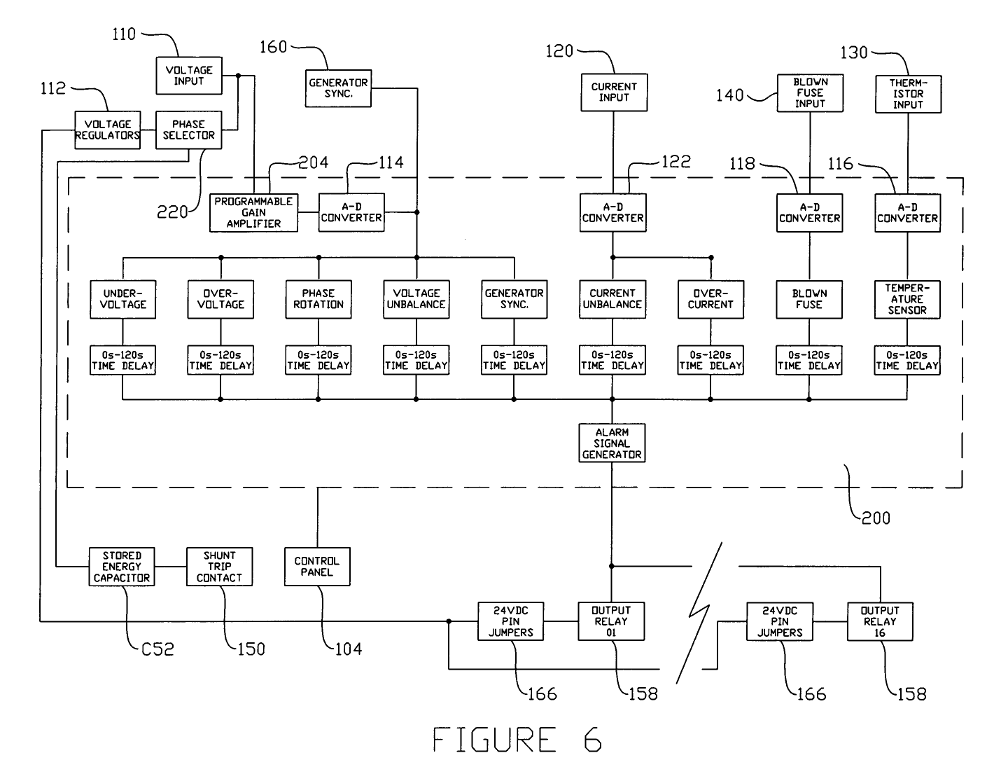

A wiring diagram of a power protection system 100 in accordance with the invention is shown in FIG. 2 as wired to a facility's power disconnect switch 10. Referring to the input/output flow diagram of FIG. 6, the power protection system 100 includes power sensing software for monitoring and sensing under-voltage, over-voltage, phase rotation, voltage unbalance (between phases), current unbalance (between phases), over-current, blown fuse detection, temperature and generator synchronization, all within the microprocessor 200. A control panel 104 is mounted in the surface of the power protection system's enclosure to provide a user interface for initial system setup, monitoring current system status and to provide easy modification of the system parameters and functions. For example, the control panel may include an LCD display 106 or other visual interface, and a control knob 108 or keypad for selecting certain system parameters or entering system information. The control panel 104 may also display or indicate which abnormal condition has occurred, when an abnormal condition has occurred.

The power protection system has four sets of input terminals (for voltage 110, current 120, thermistor input 130 and blown fuse detection 140) and one output 150 to the main power disconnect switch's shunt trip coil. Thus, installation of the power protection system of the invention requires substantially fewer wire connections than prior systems.

The voltage input block 110 accepts one tap from each of the main power service's three phases (A, B, C) and the neutral. The voltage input at this one block 110 is used for monitoring and sensing all of the potential voltage abnormalities, including under-voltage, over-voltage, phase rotation and voltage unbalance. This input voltage also provides power to the voltage regulators 112 (FIG. 6) that provide control power within the system.

Many prior protection systems cannot maintain system power that is derived from a three-phase AC system when one or two of the phases go offline. This is because the system uses one of the three phases exclusively to power the device. If that one phase is lost, the other two, regardless of condition, will not be used. Therefore, the system will be dead. Thus, prior systems use a “dead man's” switch that drops out when there is a fault or the critical phase is lost, potentially providing a false alarm.

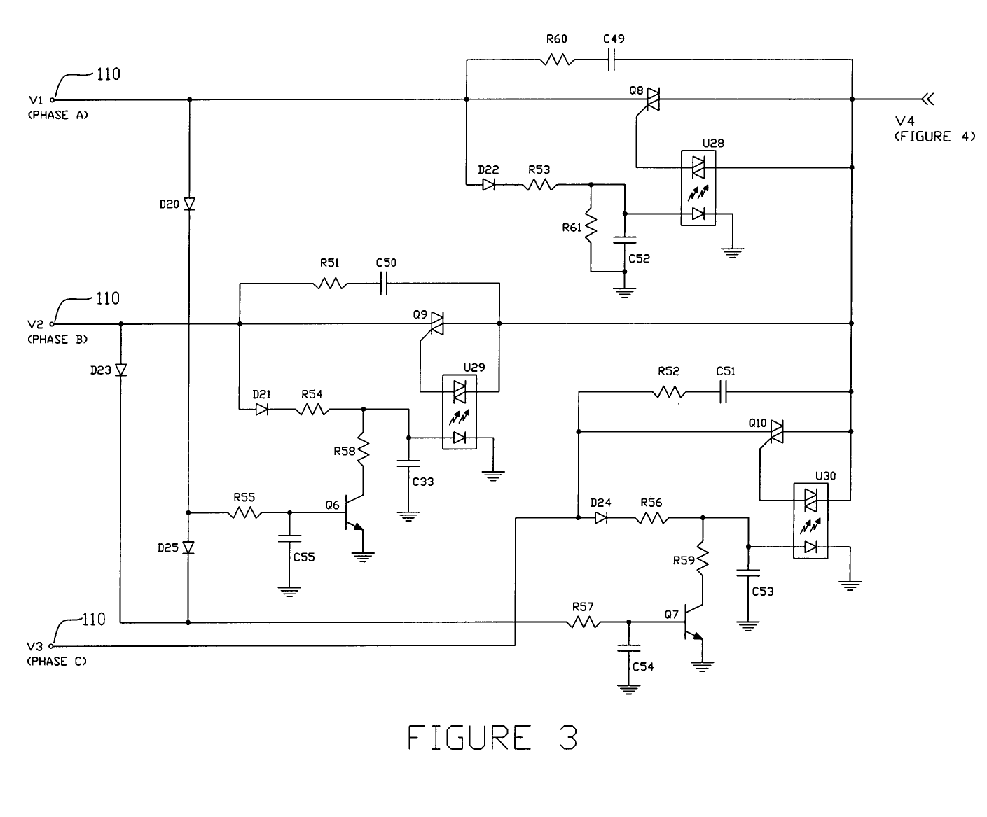

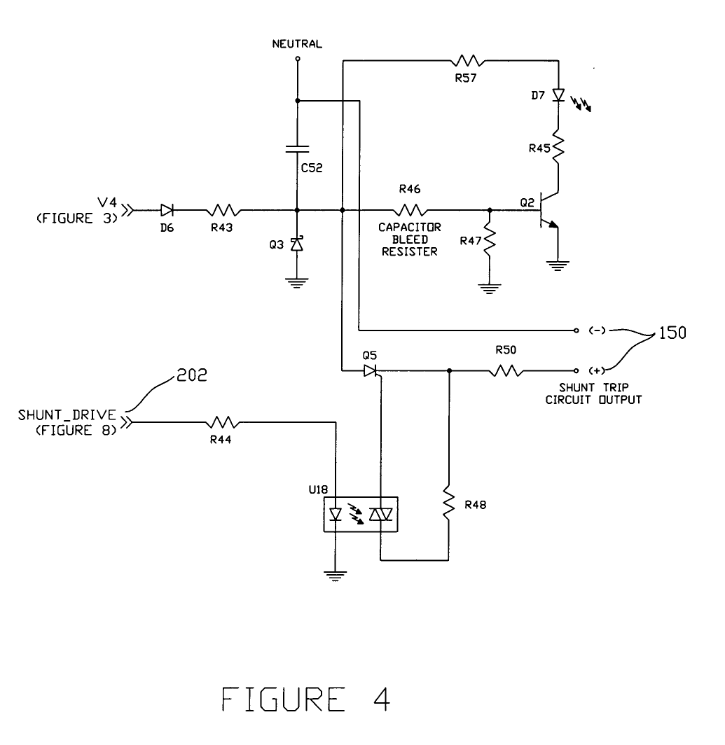

The power protection system of the present invention remains operational even when one or two of the phases are lost. Referring to FIG. 3, a phase selection circuit is used to select any of the three phases, as long as one of the phases is active, and to output the selected phase to a voltage regulator circuit 112 for use in the system and to a Shunt Trip Circuit (FIG. 4). Under normal three phase conditions (all three phases active), voltages A, B & C enter the phase selection circuit at points V1, V2 & V3. Three triac switching circuits control the phase that continues to V4. Under normal conditions, Triac Q8 is on while Q9 and Q10 are off. This allows the power from V1 to continue to Vout. In this mode of operation, Triacs Q9 and Q10 are turned off when current passes through diodes D20 and D23 and saturate transistors Q6 and Q7. Turning on transistors Q6 and Q7 removes current flow to opto-isolators U29 and U30, which subsequently turn off Triacs Q9 and Q10. In the event power is lost from V1, transistor Q6 would turn off, causing Triac Q9 to turn on and allow V2 to continue to V4. This type of logic is used to provide power to the voltage regulators 112 and shunt trip circuit (FIG. 4) as long as there is at least one phase active. Table I, below, illustrates the logic of the circuit.

TABLE I

| V1 | V2 | V3 | Q6 | Q7 | U28 | U29 | U30 | Q8 | Q9 | Q10 | V4 |
|---|---|---|---|---|---|---|---|---|---|---|---|
| ON | ON | ON | ON | ON | ON | OFF | OFF | ON | OFF | OFF | A |
| OFF | ON | ON | OFF | ON | OFF | ON | OFF | OFF | ON | OFF | B |
| ON | OFF | ON | ON | ON | ON | OFF | OFF | ON | OFF | OFF | A |
| ON | ON | OFF | ON | ON | ON | OFF | OFF | ON | OFF | OFF | A |
| OFF | OFF | ON | OFF | OFF | OFF | OFF | ON | OFF | OFF | ON | C |
| ON | OFF | OFF | ON | ON | ON | OFF | OFF | ON | OFF | OFF | A |
| OFF | ON | OFF | OFF | ON | OFF | ON | OFF | OFF | ON | OFF | B |

The selected phase is output to the voltage regulators 112 for converting the raw input voltage to a lower voltage usable by the system. The regulated voltage is used for powering the components of the power protection system. Regulator circuits of these types are commonly known in the industry and are therefore not shown or described in any further detail herein.

The selected raw voltage is also input to the shunt trip circuit shown in FIG. 4, where it is regulated by zener diode Q3. When the shunt trip circuit receives a drive signal 202 from the microprocessor 200, derived from any of the abnormal power sensing algorithms, opto-isolator U18 is turned on, which turns on triac Q5 and delivers power to the shunt trip output 150. This activates the shunt trip solenoid 14 in the facility's power disconnect. In the event of a total power loss, a user may want to open (shunt trip) the power disconnect. If all three phases are lost, however, there is no input power at V4 to deliver to the shunt trip 14. Therefore, a stored energy capacitor C52 stores the energy to power the shunt trip 14 under these conditions. During normal conditions, energy from V4 is stored in capacitor C52. This energy will be used in the event there is no voltage at V4 to deliver to the shunt trip output 150. Thus, the shunt trip 14 may be activated even when none of the three phases are active. For safety, LED D7 in FIG. 4, will illuminate when there is a charge present in capacitor C52. A bleed resistor R46 is provided in the circuit to discharge capacitor C52 when the system is powered down and no charge is required in capacitor C52.

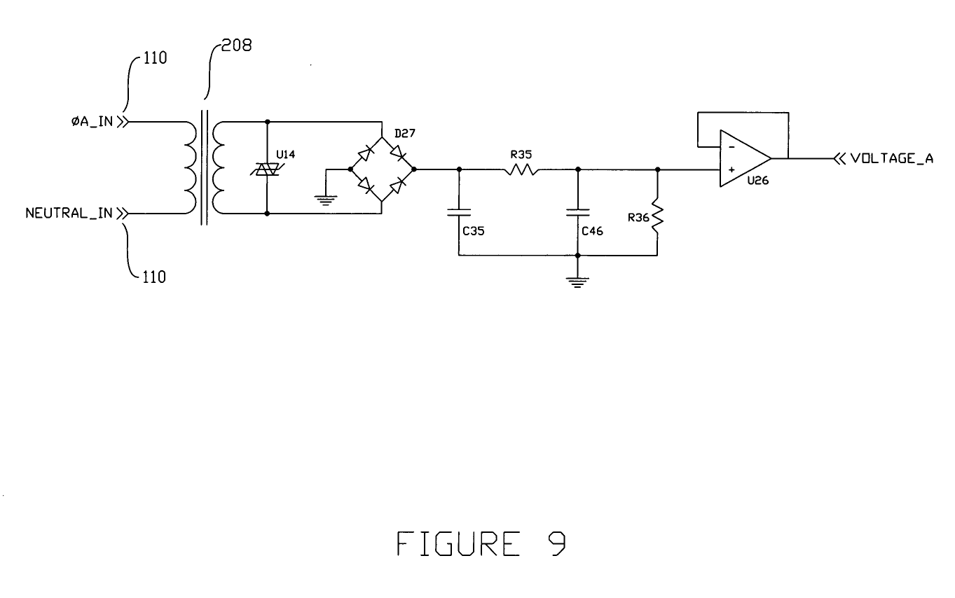

Referring to FIG. 2, the voltage input block 110 receives raw input voltages from the system being monitored via wire taps 68. The present invention monitors these voltages for abnormalities as well as uses them to power the system and any other external loads. For the purpose of voltage monitoring, the system is auto-ranging for any system voltage up to 600V. However, the transformers and voltage regulator circuits of the power protection system may be readily modified to increase the voltage operating range. This method is used to maintain optimal resolution at lower operating voltages. The input voltages are converted to digital using a 12-bit analog to digital (A-D) converter 114 embedded in the microprocessor 200. Shown in FIG. 9, prior to entering the A-D converter, the raw voltage is adjusted to yield 3VDC at full input voltage. An isolation transformer 208 is used to step-down the input voltage and well as isolate the circuit from external voltage spikes. A full wave rectifier D27 and low pass filter (C35, R35, C46) converts the AC signal to DC. The resistor divider (R35 & R36) in conjunction with isolation transformer 208 is calibrated to output 3VDC at full input voltage at input block 110. Using a 12-bit A-D converter there are 4095 possible digital values for voltage. With full-scale input voltage, plus 150%, at inputs 110, the A-D converter 114 will register 4095. At zero volts it will register 0000. Upon system startup, the CPU samples the digital input voltage values. If the value is below half scale (2048), the microprocessor is programmed to engage a 2× programmable gain amplifier 204 at the input of the A-D converter 114. This will increase the analog input voltage to the A-D converter and thus increase the resolution of the samples.

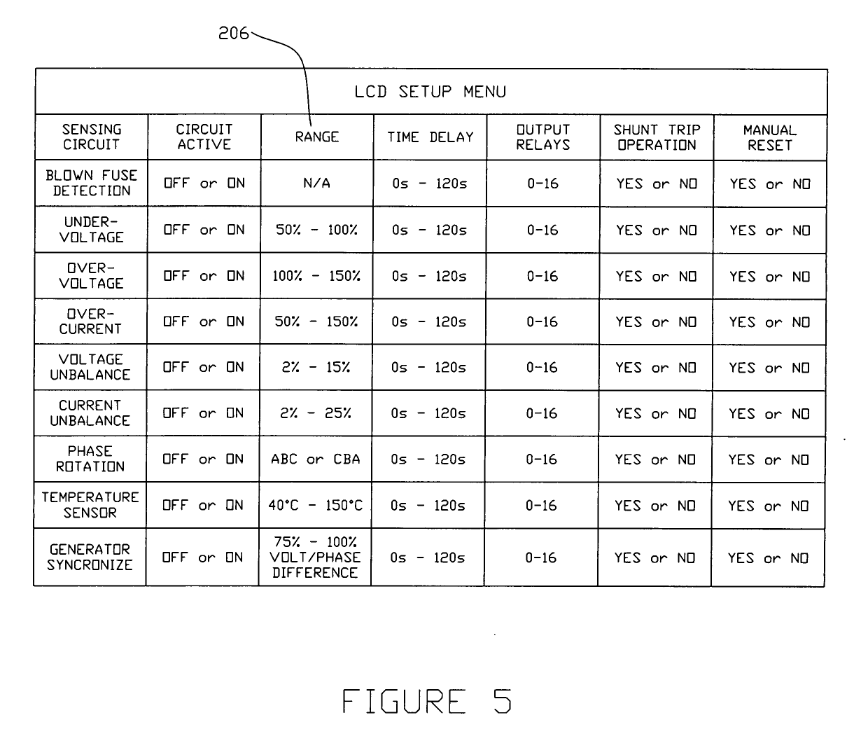

After the appropriate amplification has been determined, a reference voltage is sampled and stored by the microprocessor 200. The abnormality range percentage settings shown in FIG. 5 will be based on this reference voltage. Having established that the reference voltage is a 12-bit digital value, all range settings 206 shown in FIG. 5 are percentages of the stored reference value. If the monitored voltage, and subsequent digital value, deviate in excess of the range settings 206, the microprocessor will react in accordance with the additional settings shown in FIG. 5. When a range setting has been exceeded, a user may want to delay the alarm, assign specific output relays 158 to close, operate the shunt trip of a power disconnect, etc.

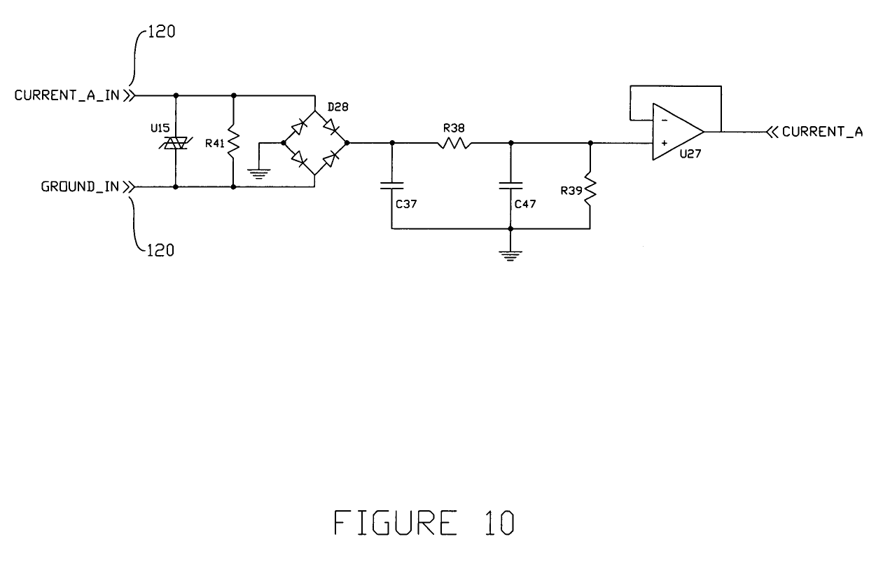

The current input block 120 receives a transformed current from the secondary side of the current transformer 44 in the facility's power disconnect switch 10. For example, using a current transformer with a 4000:5 amp ratio, if the operating current of the disconnect switch is 4000 amps, the secondary output is 5 amps. Using the same current transformers 44, if the disconnect switch operates at 2000 amps, the secondary output is 2.5 amps. Referring to FIG. 10, resistor R41 is used to establish a voltage from the current source of current transformers 44. This AC voltage at R41 is then converted to 3VDC in a similar manner as the voltage input circuit described above and illustrated in FIG. 3. The converted current signal is then input to the embedded A-D converter 122. The microprocessor 200, uses software algorithms to sense current abnormalities in the same way it senses voltage abnormalities. Auto-ranging is not required when using current transformers. The current input to the power protection system is always 0-5 amps, regardless of the switch's operating current.

The thermistor input block 130 receives a signal indicative of the temperature of the surface to which the temperature probe is attached. An industry standard thermistor circuit is provided in a separate package wired to thermistor inputs 130. The circuit will output 0-3VDC for a temperature range of 0-150 degrees Celsius. This is input to the microprocessor, via embedded A-D converter 116, which may be programmed to set off an alarm or activate the shunt trip circuit if the temperature exceeds the temperature setting in the user setup menu.

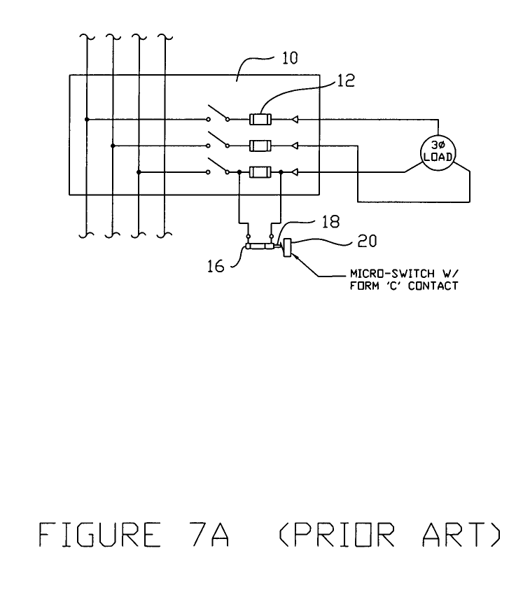

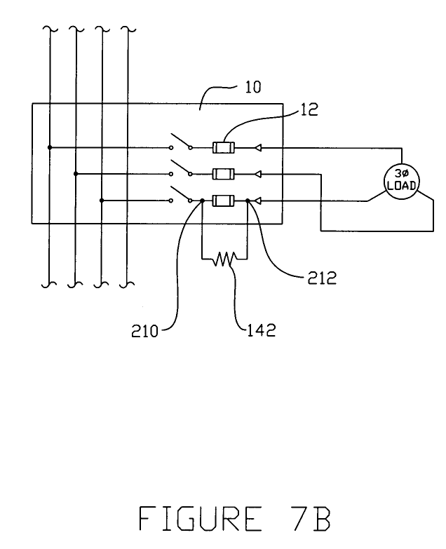

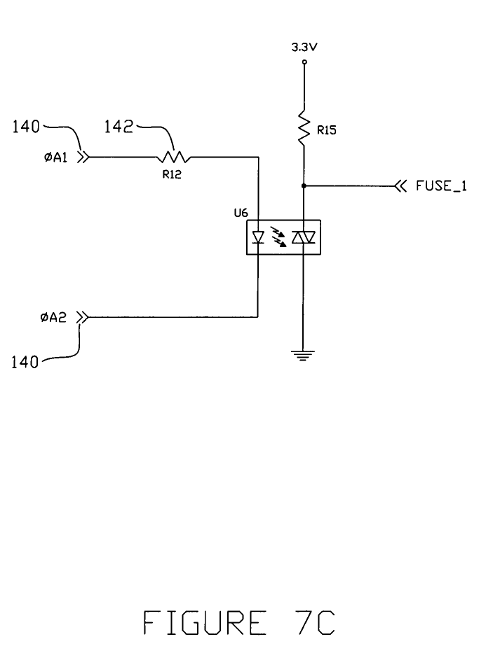

The blown fuse detector inputs are used for detecting if one or more of the power disconnect switch's main fuses 12 have blown. As shown in FIG. 7B, a tap is placed on the line side 210 and the load side 212 of the main fuse 12. This is wired to the corresponding blown fuse detector input 140 for each phase (for example, A₁ and A₂). A resistor 142 in the blown fuse detection circuitry (FIG. 7C) is wired between each of the taps for each main fuse 12 (for example, between A₁ and A₂), as shown in FIG. 7B. FIG. 7C shows that when there is a blown fuse, there is a current flow through R12, which activates opto-isolator U6. This grounds the output FUSE_1 and sends a logic low to the microprocessor 200. Under normal conditions, there is no current flow through R12 and the output FUSE_1 sends a logic high to the microprocessor. The microprocessor 200 will react to the logic low based on the user settings detailed in FIG. 5. This may be the activation of the shunt trip, switching output relays, etc.

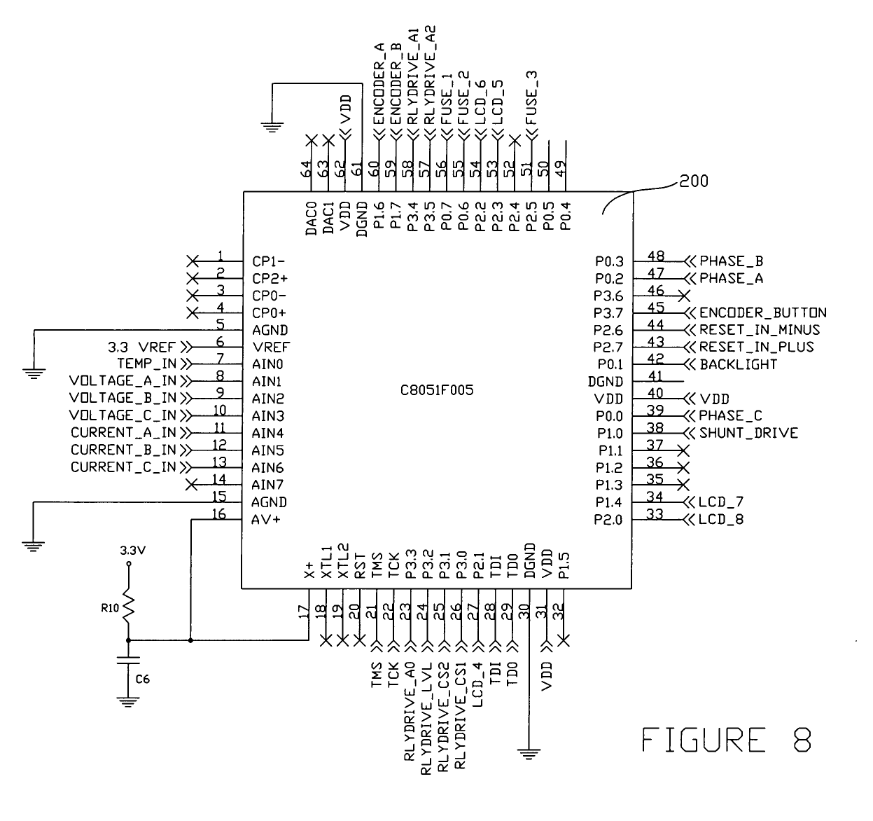

The power monitoring features of the invention is performed by the software based abnormal power sensing algorithms (or PSAs). As set forth above, analog to digital converters are used to quantize the raw power inputs for use in the microprocessor. Within the microprocessor, the PSAs monitor the digital inputs for voltage, current, temperature and blown fuses status, with respect to the menu settings shown in FIG. 5. Other PSAs may be added by modifying the software in the microprocessor. Terminals are provided for field modification of the software (FIG. 8, pins 21 & 22).

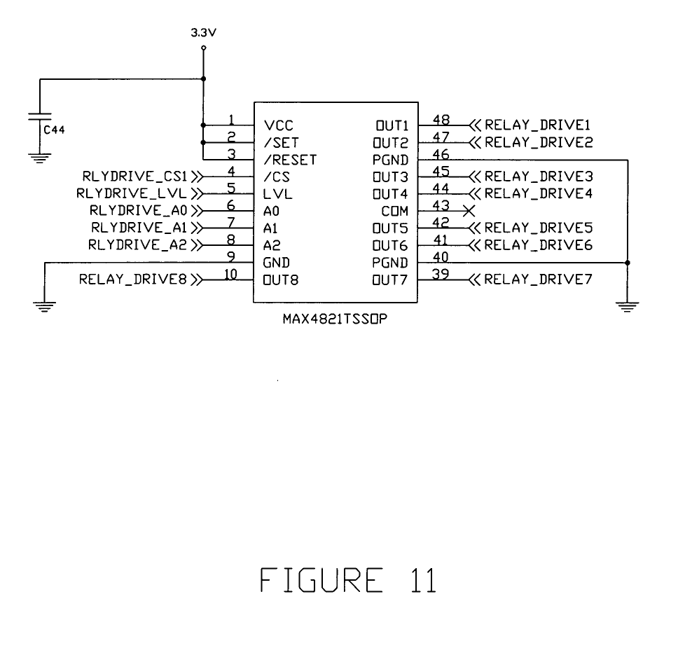

Referring to FIG. 2, the power protection system preferably includes 16 output relays 158. However, more output relays could easily be added. The output relays are simply Form ‘C’ contacts that are controlled by signals sent from the microprocessor. The microprocessor 200 sends a 3-bit address (FIG. 8, Pins 23, 57, 58) to the integrated circuit (IC) shown in FIG. 11. Along with the 3-bit address, a chip select bit (FIG. 8, Pins 25, 26) and a data bit (FIG. 8, Pin 24) are sent to the IC. The chip select bit is used to select between the two IC's required to drive 16 output relays 158. Each IC can control up to 8 output relays. The data bit is a logic high (3.3V) to turn the relay on, or a logic low (0V) to turn the relay off.

The output relays 158 function as user outputs that can be used for a variety of operations. Typically they are used as dry contacts for building management systems. However, the output relays can also be used to control items such as pilot lights, bell alarms, etc. Control power for the output relays 158 is available and assignable on the circuit board by pin jumpers 166. This could also be achieved by software control through the setup menu. This control power is being derived from the voltage input 110 via voltage regulators 112. This eliminates the need for separate control power transformers and external power supplies, as required by prior art systems. An industry standard 24VDC voltage regulator 112 is fed from the phase selection circuit 220 and tied to pin jumpers 166 on the PCB 102. The output relays 158 are user assignable to any of the sensing algorithms through the setup menu. Additionally, more than one output relay 158 can be assigned to a particular PSA. Conversely, more than one PSA can be assigned to a particular output relay. Terminal blocks 162 are used for connecting the output relays to lights, buzzers, alarms, building management systems or other external devices.

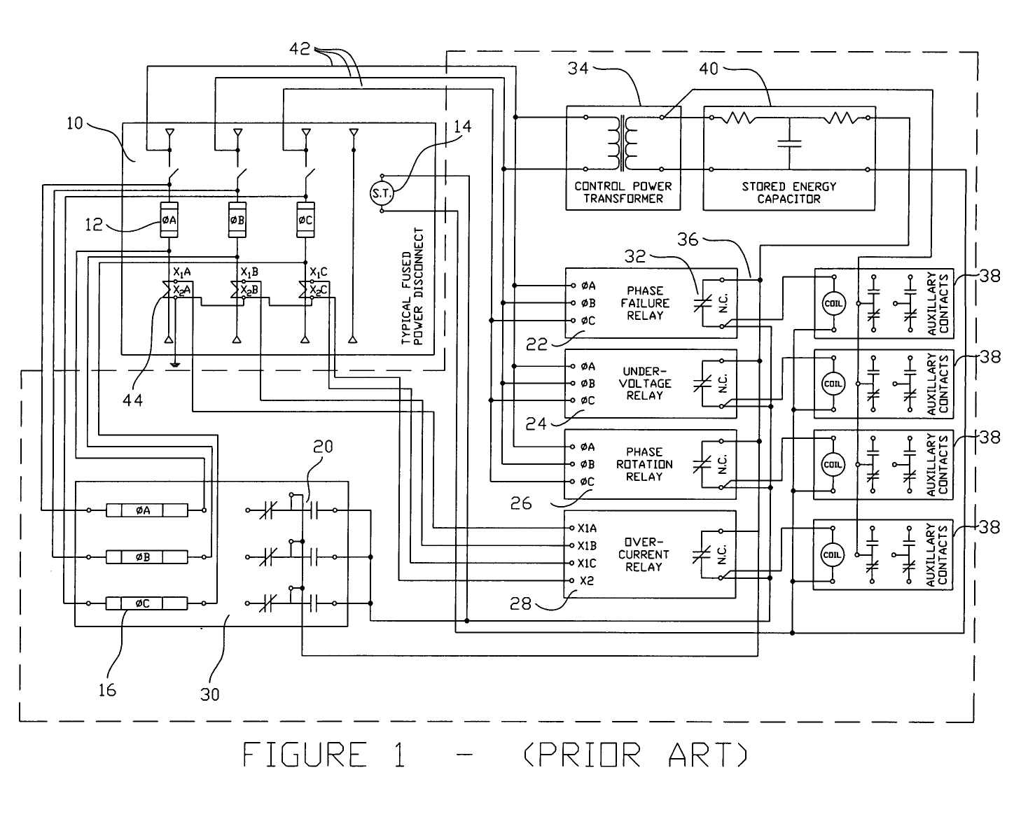

A shunt trip output contact is also integral to the power protection system of the invention. A preferred type of shunt trip contact is a solid state, SCR type, output contact U18 (FIG. 4). The contact delivers a control signal to a shunt trip 14 should the microprocessor 200 detect an abnormal condition. In accordance with the present invention, shunt trip functionality is reduced to a single contact because all of the sensing algorithms are software based and selectable via the setup menu and the shunt tripping voltage is derived on the device itself. In prior systems, such as the system shown in FIG. 1, shunt trip control power was derived from an external power source (such as a transformer 34), wired to several dry contacts of multiple sensing devices, which were then wired to the shunt trip coil 14. The power protection system of the present invention internally regulates the system's voltage to the required shunt tripping voltage without the need for an external transformer, again reducing parts and assembly time. See FIGS. 3 & 4. An operational block diagram of a power protection system in accordance with the invention is shown in FIG. 6.

An additional feature of the power protection system 100 is its ability to be synchronized with additional power protection systems. Certain situations may require two or more power sources to be on a common bus. This can only occur if both power sources are operating at the same voltage and phase rotation. In situations where there are two or more power disconnect switches 10, a power protection system 100 can be installed on each power disconnect switch 10 to permit monitoring of voltage and phase in each power disconnect switch. The power monitoring systems 100 are then wired together via the generator sync 160 (see FIG. 2). If the voltage and/or phase angle detected in one of the systems are different than the voltage and/or phase angle in the other system, an alarm signal is generated by the microprocessor 200. This is achieved by digitizing the input voltages of the individual power sources, as described hereinbefore, and comparing the values of the separate units using the generator sync PSA.

Using the setup menu shown in FIG. 5, the alarm signals generated by the PSAs in the microprocessor 200 can be routed to either activate the shunt trip contact 150, actuate one or more of the output relays 158, or both. A preferred, simplified, setup menu for several power sensing algorithms is shown in FIG. 5. Other power sensing circuits may be added by software modification if desired. Column 1 shows the type of sensing algorithm. Columns 2-7 show the various options for each sensing algorithm shown in Column 1.

Column 2 allows a user to activate or deactivate the sensing algorithm. Column 3 allows the user to set the detection threshold. For example, in the under-voltage sensing algorithm, a user can set the detection threshold anywhere between 50-100% of the reference voltage. Column 4 allows a user to set the time delay for a specific sensing circuit to prevent, for example, nuisance tripping. This is useful to avoid tripping when, the system senses a temporary abnormal power condition, which is remedied without user intervention. Column 5 allows a user to assign one or more output relays 158 to a sensing algorithm (to operate, e.g., an alarm or illuminate a light) in addition to the shunt trip circuit 150. In certain situations, it is not desirable to activate the shunt-trip 14. Instead, it may only be desirable to sound an alarm or illuminate a light. Thus, Column 6 allows a user to decide whether the shunt-tripping capability is assigned to each sensing algorithm. Column 7 allows a user to select whether each power sensing algorithm alarm can automatically reset, or requires a manual reset. This is useful when an abnormal power condition is temporary and remedies, such as overnight power sag that nobody witnesses. The setup menu may also be used to set certain system operating voltages, for example, for the shunt trip output.

A further advantage of the power protection system is its ambient temperature operating range of 0° C. to 105° C. Most prior stand-alone power monitors have a maximum operating temperature of 55° C. These devices are often located in areas where the ambient temperature can exceed its designed operating temperatures (electrical switchgear rooms, boiler rooms, machine rooms, etc.), which may cause undesirable operation of the electronic circuits. The present invention does not have this problem.

Although the invention has been described with reference to preferred embodiments, which should be construed in an illustrative and not limiting sense, it will be appreciated by one of ordinary skill in the art that numerous modifications are possible in light of the above disclosure. For example, a non-microprocessor based circuit may be employed using analog devices, the output display may be larger (e.g., seven segments) or it may include a color, touch-screen interface for menu programming and monitoring. Further, the present device may be configured to control more than 16 output relays, may possess a real-time clock event logging, the apparatus may be integrated with workstations, workstation software and programmable logic controllers (PLCs), the printed circuit boards may be fabricated to have multiple layers, and multiple temperature sensing inputs could be used for monitoring the temperature at more than one location. Further still, the device may be configured to switch power disconnects or circuit breakers on as well as off. Additionally, a battery backup (UPS), or alternate power source may be used to provide power if all primary input power is lost. The system may also be configured to operate on other than three-phase AC systems. The system may be modified to sense ground fault currents, line harmonics and transients. Further, the transformers and voltage regulator circuits of the power protection system may be readily modified to increase the voltage operating range of the power protection system. All such variations and modifications are intended to be within the scope and spirit of the invention, as defined in the following claims:

1. An integrated power protection system for monitoring power supplied to a load through a power disconnect switch that is opened by activation of a shunt trip solenoid, comprising:
a voltage input for receiving at least one voltage phase of the power;
a current input for receiving at least one current phase of the power;
a microprocessor programmed to sense a plurality of abnormal power conditions in the at least one voltage phase and the at least one current phase, and to output an alarm signal in response to sensing of any of the plurality of abnormal power conditions; and
an output circuit for alerting a user of the existence of at least one of the abnormal power conditions upon receiving the alarm signal from the microprocessor.

2. A power protection system according to claim 1, wherein the at least one voltage phase supplies control power to the system.

3. A power protection system according to claim 1, wherein the power disconnect switch comprises a main fuse for each of the at least one voltage phase of the power and the system further comprises at least one set of blown fuse detector inputs for detecting voltage on both sides of the main fuse and a resistor connected between each of the at least one set of blown fuse detector inputs, the microprocessor sensing a voltage drop across the resistor indicative of the main fuse being blown.

4. A power protection system according to claim 1, wherein the output circuit is a shunt trip circuit for activating the shunt trip solenoid in the power disconnect switch.

5. A power protection system according to claim 1, wherein the output circuit comprises at least one output relay for illuminating a light, activating a buzzer or communicating with a power management system of the facility.

6. A power protection system according to claim 5, wherein the microprocessor is programmed with power sensing algorithms for sensing the abnormal power conditions, and more than one of the at least one output relay may be assigned to each of the power sensing algorithms.

7. A power protection system according to claim 5, wherein the microprocessor is programmed with power sensing algorithms for sensing the abnormal power conditions, and more than one of the power sensing algorithms may be assigned to each of the at least one output relay.

8. A power protection system according to claim 1, further comprising a user interface for programming setup information into the system, the user interface comprising a screen and means for selecting certain options on the screen.

9. A power protection system according to claim 1, wherein the abnormal power conditions may be selected from the group consisting of: blown fuse detection, under-voltage, over-voltage, over-current, voltage unbalance, current unbalance, phase rotation, temperature sensor, generator synchronization, ground fault currents, line harmonics, and transients.

10. A power protection system according to claim 9, further comprising a temperature sensor input for providing temperature information to the microprocessor.

11. A power protection system according to claim 1, wherein the power comprises three phases and the system further comprising a phase selection circuit for selecting one of the three phases for use in the system, such that if one of the phases is not operational, another of the phases will be selected.

12. A power protection system according to claim 11, wherein the phase selection circuit comprises three triac switching circuits that are selectively turned on and off depending on which of the three phases is active.

13. A power protection system according to claim 11, wherein the shunt trip output circuit comprises a stored energy capacitor for providing power to the shunt trip solenoid in the event that none of the three phases are active.

14. A method for monitoring power supplied to a load through a power disconnect switch that is opened by activation of a shunt trip solenoid, comprising the steps of:
wiring a voltage tap from at least one voltage phase of the power in the disconnect switch to a voltage input in an integral power protection system;
wiring a current tap from at least one current phase of the power in the disconnect switch to a current input in the integral power protection system;
monitoring the at least one voltage phase and the at least one current phase for a plurality of abnormal power conditions, and outputting an alarm signal in response to sensing of any of the plurality of abnormal power conditions; and
activating an output circuit in response to the alarm signal to alert a user of the existence of at least one of the abnormal power conditions.

15. A method according to claim 14, further comprising the step of using the at least one voltage phase to supply control power to the integral power protection system.

16. A method according to claim 14, wherein the power disconnect switch comprises a main fuse for each of the at least one voltage phase of the power; the method further comprising monitoring a voltage across a resistor connected on both sides of the main fuse and activating the alarm signal in response to a voltage drop across the resistor indicative of the main fuse being blown.

17. A method according to claim 14, wherein the output circuit activates the shunt trip solenoid in the power disconnect switch in response to the alarm signal.

18. A method according to claim 14, wherein the output circuit illuminates a light, activates a buzzer or communicates with a building management system of the facility in response to the alarm signal.

19. A method according to claim 14, further comprising the step of programming setup information into the system through a screen and means for selecting certain options on the screen.

20. A method according to claim 14, further comprising the step of monitoring a temperature in the power disconnect switch and activating the alarm signal in response to a change of temperature outside a preset acceptable range.

21. A method according to claim 14, wherein the power comprises three phases and the method further comprises the step of selecting one of the three phases for use in the system, such that if one of the phases is not operational, another of the phases will be selected.
